(19) United States
(12) Patent Application Publication
(10) Pub. No.: US 2013/0320606 A1
(43) Pub. Date: Dec. 5, 2013

(54) WAVE SOLDERING CARRIER

(71) Applicants: Hong Fu Jin Precision Industry (ShenZhen) Co., Ltd., (US); HON HAI PRECISION INDUSTRY CO., LTD., New Taipei (TW)

(72) Inventors: TAO ZHAO, Shenzhen (CN); XIAO-CONG WEI, Shenzhen (CN); WEI-HSIEN TSENG, New Taipei (TW)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/873,115

(22) Filed: Apr. 29, 2013

(30) Foreign Application Priority Data
May 31, 2012 (CN) 2012101751386

(51) Int. Cl. B23K 3/08

(52) U.S. Cl. CPC B23K 3/087
USPC 269/287

(57) ABSTRACT

A wave soldering carrier includes a base plate and a fixing member positioned on the base plate. The base plate defines a receiving recess and a number of through holes communicating with the receiving recess. The receiving recess receives a circuit board. The through holes are arranged and shaped corresponding to a number of electronic components on the circuit board. The fixing member includes a shaft including a fixing shaft fixed to the base plate and a restricting shaft extending from an end of the fixing shaft. A diameter of the restricting shaft is greater than that of the fixing shaft, thereby forming a step. The fixing member further includes a rotatable member rotatably connected to the fixing shaft and sandwiched between the shoulder and the base plate. The rotation member is rotatable to a preset position, where a distal end of the rotatable member firmly contacts the circuit board.

### BACKGROUND

1. Technical Field

The present disclosure relates to a wave soldering carrier.

2. Description of Related Art

Generally, during wave soldering, a wave soldering carrier for carrying a circuit board is positioned on claws extending from opposite sidewalls of a tin bath. The wave soldering carrier defines a number of though holes aligned with a number of electrical elements of the circuit board. During wave soldering, the circuit board may shift or move about under impact from solder waves in the tin bath, which negatively impacts the wave soldering.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric view of a wave soldering carrier.

FIG. 2 is a partial exploded isometric view of the wave soldering carrier in FIG. 1.

### DETAILED DESCRIPTION

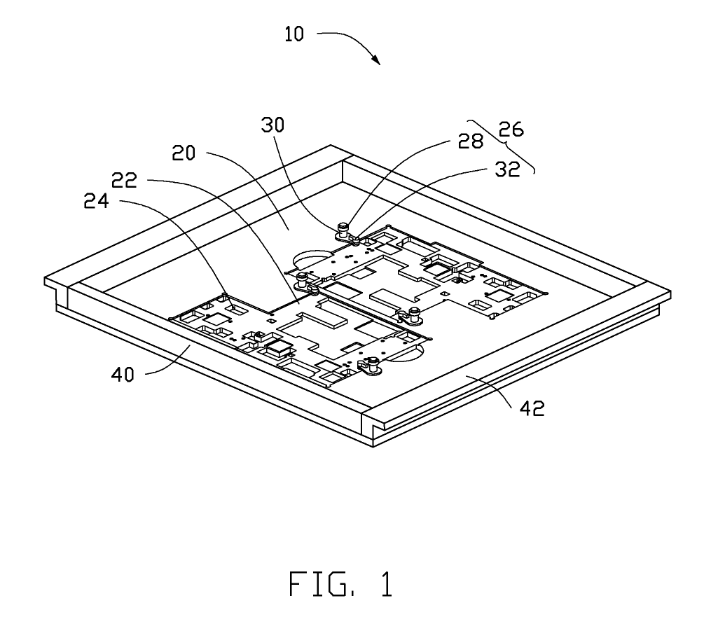

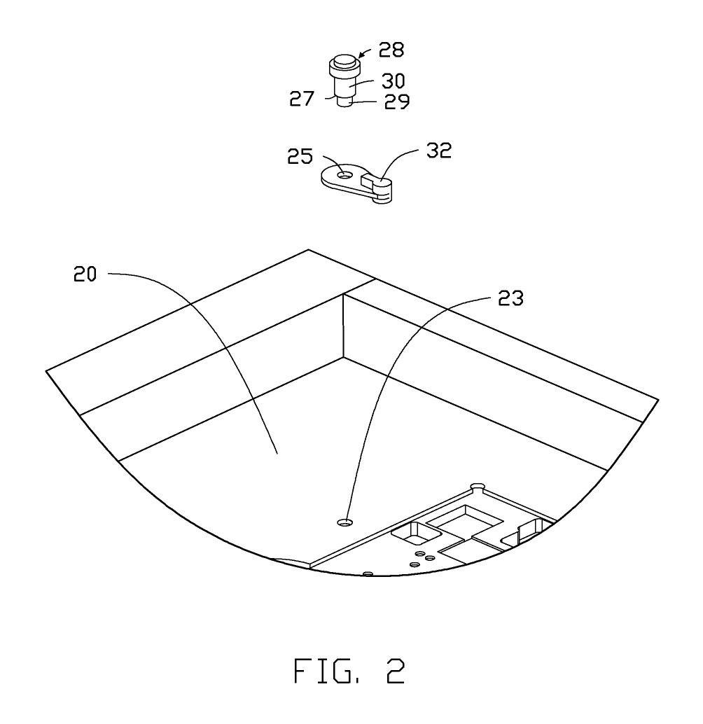

Referring to FIGS. 1 and 2, a wave soldering carrier 10 according to an exemplary embodiment includes a base plate 20 and sidewalls 40 extending from edges of the base plate 20. A receiving recess 22 is defined extending partway through the base plate 20, and a number of through holes 24 are defined through the bottom of the receiving recess 22. A contour of the receiving recess 22 is shaped conforming to the circuit board (not shown). The receiving recess 22 is used to receive the circuit board. The through holes 24 are sized and arranged corresponding to the electronic components of the circuit board so that when a circuit board is put in the receiving recess 22, only the parts of the circuit board needing to be soldered are exposed through the holes 24. The base plate 20 defined a plurality of fixing holes 23 around the receiving recess 22.

The wave soldering carrier 10 includes a number of fixing members 26 positioned on the base plate 20 along the periphery of the receiving recess 22 to fix the circuit board in the receiving recess 22. Each fixing member 26 includes a shaft 28 that includes a fixing shaft 29 for insertion into one of the fixing holes 23 of the base plate 20 and a restricting shaft 30 extending from an end of the fixing shaft 29. A diameter of the restricting shaft 30 is greater than that of the fixing shaft, thus forming a step 27. In the exemplary embodiment, each the fixing shaft 29 is threaded, and each the fixing hole 23 is threaded. The fixing shafts 29 are screwed into the threaded holes 23 to fix the fixing members 26 on the base plate 20.

Each fixing member 26 further includes a rotatable member 32 defining a through hole 25. The rotatable member 32 is sleeved on the fixing shaft 29 through the through hole 25, thus, the rotatable member 32 is rotatably connected to the fixing shaft 29. The rotatable member 32 is sandwiched between the base plate 20 and the step 27, and thus cannot move along the fixing shaft 29. When the rotation member 32 rotates about the fixing shaft 29 to a first position, the rotatable member 32 is positioned over the receiving recess 22 and a distal end of the rotation member 32 contacts a top surface of the circuit board, thus holding the circuit board firmly in position. After wave soldering, the rotation member 32 is moved away from the receiving recess 22, thus allowing the circuit board to be taken out from the receiving recess 22.

The sidewalls 40 help prevent solder from falling onto the side of the circuit board not needing wave soldering. Two ledges 42 are formed on opposite sidewalls 40 and extend away from each other. The two ledges 42 rest on claws extending from opposite sidewalls of a tin bath to support the wave soldering carrier 10. The two ledges 42 are parallel to the base plate 20 and for being held in place on a tin bath by some clamping means.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A wave soldering carrier comprising:
a base plate defining a receiving recess for receiving a circuit board therein and a plurality of through holes defined in a bottom in the receiving recess, a contour of the receiving recess being shaped conforming to the circuit board, the through holes communicating with the receiving recess, and the through holes being arranged and shaped corresponding to a plurality of electronic components on the circuit board, the base plate defining a plurality of fixing holes around the receiving recess;
a fixing member positioned on the base plate, the fixing member comprising:
a shaft comprising a fixing shaft for insertion into one of the fixing holes of the base plate and a restricting shaft extending from an end of the fixing shaft, a diameter of the restricting shaft being greater than that of the fixing shaft, thereby forming a step therebetween;
a rotatable member rotatably connected to the fixing shaft and sandwiched between the step and the base plate;
wherein the rotation member is rotatable between a first position where the rotatable member is moved over the receiving recess and a distal end of the rotatable member is configured to firmly contact a top surface of the circuit board, and a second position where the rotation member is moved away from the receiving recess thus allowing the circuit board to be taken out from the receiving recess.

2. The wave soldering carrier as described in claim 1, further comprising two opposite sidewalls extending from opposite edges of the base plate, wherein two ledges are formed on the opposite sidewalls and extend away from each other, the two ledges are parallel to the base plate.
